(19) United States
(12) Patent Application Publication
(10) Pub. No.: US 2010/0018710 A1
(43) Pub. Date: Jan. 28, 2010

(54) FRACTURING FLUID COMPOSITIONS, METHODS OF PREPARATION AND METHODS OF USE

(75) Inventors: Timothy Tyler Leshchyshyn, Calgary (CA); Peter William Beaton, Calgary (CA); Thomas Michael Coolen, Calgary (CA)

Correspondence Address: DAVIDSON BERQUIST JACKSON & GOWDEY LLP, 4300 WILSON BLVD., 7TH FLOOR, ARLINGTON, VA, 22203, US

(73) Assignee: Century Oilfield Services Inc., Calgary (CA)

(21) Appl. No.: 12/207,731

(22) Filed: Sep. 10, 2008

(30) Foreign Application Priority Data
Jul. 25, 2008 (CA) 2635989

(51) Int. Cl. E21B 43/267; C09K 8/68; C09K 8/60

(52) U.S. Cl. 166/280.2; 507/266; 507/213; 507/201

(57) ABSTRACT

The invention describes improved fracturing compositions, methods of preparing fracturing compositions and methods of use. Importantly, the subject invention overcomes problems in the use of mists as an effective fracturing composition particularly having regard to the ability of a mist to transport an effective volume of proppant into a formation. As a result, the subject technologies provide an effective economic solution to using high ratio gas fracturing compositions that can be produced in a continuous (i.e. non-batch) process without the attendant capital and operating costs of current pure gas fracturing equipment.

### FIELD OF THE INVENTION

The invention describes improved fracturing compositions, methods of preparing fracturing compositions and methods of use. Importantly, the subject invention overcomes problems in the use of mists as an effective fracturing composition particularly having regard to the ability of a mist to transport an effective volume of proppant into a formation. As a result, the subject technologies provide an effective economic solution to using high ratio gas fracturing compositions that can be produced in a continuous (i.e. non-batch) process without the attendant capital and operating costs of current pure gas fracturing equipment.

### BACKGROUND OF THE INVENTION

As is well known in the hydrocarbon industry, many wells require “stimulation” in order to promote the recovery of hydrocarbons from the production zone of the well.

One of these stimulation techniques is known as “fracturing” in which a fracturing fluid composition is pumped under high pressure into the well together with a proppant such that new fractures are created and passageways within the production zone are held open with the proppant. Upon relaxation of pressure, the combination of the new fractures and proppant having been forced into those fractures increases the ability of hydrocarbons to flow to the wellbore from the production zone.

There are a significant number of fracturing techniques and fluid/proppant compositions that promote the formation of fractures in the production zone and the delivery of proppants within those fractures. The most commonly employed methodologies seek to create and utilize fracturing fluid compositions having a high viscosity that can support proppant materials so that the proppant materials can be effectively carried within the fracturing fluid. In other words, a viscous fluid will support a proppant within the fluid in order that the proppant can be carried a greater distance within the fracture or in some circumstances carried at all. In addition, fracturing fluids are commonly designed such that upon relaxation of viscosity (or other techniques) and over time (typically 90 minutes or so), the fluid viscosity drops and the proppant is “dropped” in the formation and the supporting fluid flows back to the wellbore. The proppant, when positioned in the fracture seeks to improve the permeability of the production zone in order that hydrocarbons will more readily flow to the well. An effective fracturing operation can increase the flow rate of hydrocarbons to the well by at least one order of magnitude. Many wells won't produce long term in an economic manner without being stimulated by methods such as fracturing.

Fracturing fluid compositions are generally characterized by the primary constituents within the composition. The most commonly used fracturing fluids are water-based or hydrocarbon-based fluids, defined on the basis of water or a hydrocarbon being the primary constituent of the specific composition. Each fracturing fluid composition is generally chosen on the basis of the subterranean formation characteristics and economics.

In the case of water-based fluids, in order to increase the viscosity of water, various “viscosifying” additives may be added to the water-based fluid at the surface such that the viscosity of the water-based fluid is substantially increased thereby enabling it to support proppant. As is known, these water-based fluids may include other additives such alcohols, KCl and/or other additives to impart various properties to the fluid as known to those skilled in the art. The most commonly used viscosifying additives are polymeric sugars that are used to create linear gels having moderate viscosities. These linear gels may be further combined with cross-linking agents that will create cross-linked gels having high viscosities.

During a fracturing operation, the fracturing fluid (without any proppant) is initially pumped into the well at a sufficiently high pressure and flow rate to fracture the formation. After fracturing has been initiated, proppant is added to the fracturing fluid, and the combined fracturing fluid and proppant is forced into the fractures in the production zone. When pressure is released and over time (typically 90 minutes), the viscosity of the fracturing fluid drops so that the proppant separates or drops out of the fracturing fluid within the formation and the “de-viscosified” fracturing fluid flows back to the well where it is removed.

One important problem in this type of fracturing is the volumes of water required and the attendant issues relating to the disposal of the water that has been pumped downhole and ultimately recovered from the well as a hydrocarbon-contaminated fluid. As a result, in some cases the industry has moved away from pure water-based fracturing fluids in favor of those technologies that utilize a high proportion of gas (usually nitrogen or supercritical carbon dioxide) as the fracturing fluid.

The use of a high proportion of gas has several advantages including minimizing formation damage, fluid supply costs and reduced disposal costs of fluid that is recovered from the well. For example, whereas water may reduce the ability of a production zone to flow by absorbance on sandstones and/or cause swelling or migration of clays that cause the production zone to plug, high gas compositions will minimize such damage or effects and will otherwise migrate from the formation more readily. Gas injected and thus recovered from a well can simply be released to the atmosphere thereby obviating the need for decontamination and disposal of a substantial proportion of the materials recovered from the well.

With high ratio gas fracturing compositions, the characteristics of the compositions can be similarly controlled or affected by the use of additives. Generally, gas fracturing compositions can be characterized as a pure gas fracturing composition (typically a fluid comprising around 100% CO₂ or nitrogen) or energized, foamed and emulsied fluids (typically a fracturing composition comprising less than about 85% CO₂ or nitrogen by volume).

A pure 100% gas fracturing composition will have minimal viscosity and instead will rely on high turbulence to transport proppant as it is pumped into the production zone. Unfortunately, while such techniques are effective in limited batch operations, the need for expensive, highly specialized, pressurized pumping, mixing and containment equipment substantially increases the cost of an effective fracturing operation. For example, a fracturing operation that can only utilize a batch process is generally limited in size to the volumetric capacity of a single pumping and containment unit. As it is economically impractical to employ multiple units at a single fracturing operation, the result is that very high volume gas fracturing operations can only be effectively employed in relatively limited circumstances. For example, a pure gas fracturing operation would typically be limited to pumping 300-32,000 kg of sand (proppant) into a well and is limited to the type of proppant that can be used in some circumstances.

The use of non-energized, energized, foamed and emulsied fluids as fracturing fluids are generally not limited to batch operations as fluid mixing and pumping equipment for such fluids is generally not at the same scale in terms of the complexity/cost of equipment that is required for pure gas operations. In other words, the mixing and pumping equipment for a non-energized/energized/ foamed/emulsied fluid fracturing operation is substantially less expensive and importantly, can produce effectively large continuous volumes of fracturing fluid mixed with proppant. That is, while a 100% gas fracturing operation may be able to deliver up to 32,000 kg of proppant to a formation, a non-energized/energized/ foamed/emulsied fluid fracturing operation may be able to deliver in excess of 10 times that amount.

The characteristics of energized, foamed and emulsied fluids are briefly outlined below as known to those skilled in the art.

An energized fluid will generally have less than 53% (volume %) gas together with a conventional gelled water phase. An energized fluid is further characterized by a continuous fluid phase with gas bubbles that are not concentrated enough to interact with each other to increase viscosity. For example, the overall viscosity of an energized fluid comprised of a linear gel and nitrogen gas may be in the range of 20 cP which is a “mid-point” between the viscosity of a typical linear-gel water phase (30 cP) and a nitrogen gas phase (0.01 cP). For a cross-linked gel, the viscosity range may be 150-1000 cP (typically 100-800 cP when mixed with gas). As is known, and in the context of this description, viscosity values measured in centipoise (cP) are dependent on shear rate. In this specification, all viscosity values are referenced to a shear rate of 170 sec⁻¹.

Foams will generally have greater than 53 vol % gas but less than about 85 vol % gas with the remainder being a gelled water phase. Foams are characterized as having a continuous fluid film between adjacent gas bubbles where the gas bubbles are concentrated enough to interact with each other to increase viscosity. Foams require the addition of foaming agents that promote stability of the gas bubbles. The viscosity of a foam will typically be in the range of 200-300 cP which may be 10 times greater than the viscosity of the gelled water phase (20-30 cP) and many times greater than the viscosity of the gas phase (0.01-0.1 cP).

A carbon-dioxide emulsion, also known as a carbon-dioxide foam, is where the internal phase is a carbon-dioxide supercritical fluid and is characterized by having a second liquid film (i.e. the water-based phase) between adjacent liquid droplets. Emulsions will generally form when the supercritical fluid concentration is greater than 53 vol % and less than about 85 vol %. Emulsions require the addition of foaming agents to promote stability. The viscosity of an emulsion may also be 10 times greater than the individual viscosities of the separate gelled water phase and supercritical gas phase.

Finally, when the gas concentration is increased above about 85% (typically 90-97%), the stability of a typical emulsion or a foam will decrease, such that the emulsion or foam will “flip” such that the gas phase becomes continuous and the water phase is dispersed with the gas phase as small droplets or in larger slugs. This is commonly referred to as a “mist”. The viscosity of a mist will generally revert to a “mid-point” of viscosity close to that of the gas (i.e. approximately 1-3 orders of magnitude lower than that of an emulsion) with the result being that the ability to support proppant based on viscosity is lost.

As a result, fracturing compositions generally avoid the formation of mists and instead favor stabilizing foams and otherwise maximizing viscosities.

A review of the prior art shows that the active promotion and use of a mist as a fracturing composition has not been considered.

For example, U.S. Pat. No. 7,261,158 discloses a high concentration gas fracturing composition that is a “coarse foam”; U.S. Pat. No. 6,844,297 discloses fracturing compositions including an amphoteric glycinate surfactant that increases viscosity and enables viscosity control of the compositions through pH adjustment; U.S. Pat. No. 6,838,418 discloses fracturing fluid including a polar base, a polyacrylate and an “activator” that ionizes the polyacrylate to a hydroscopic state; U.S. Pat. No. 4,627,495 discloses methods using carbon dioxide and nitrogen to create high gas concentration foams; U.S. Pat. No. 7,306,041 discloses acid fracturing compositions that contain a gas component; US Publication 2007/0204991 describes a method and apparatus for fracturing utilizing a combined liquid propane/nitrogen mixture; US Publication 2006/0065400 describes a method for stimulating a formation using liquefied natural gas; and, US Publication 2007/0023184 describes a well product recovery process using a gas and a proppant.

### SUMMARY OF THE INVENTION

In accordance with the invention, there is provided fracturing fluid compositions and methods of preparing and using such compositions for fracturing a well.

In its broadest form, the fracturing fluid compositions comprise: a liquid component for temporarily supporting a proppant within the liquid component at surface, the liquid component including a viscosified water component having a viscosity sufficient to temporarily support proppant admixed within the viscosified water component; and, a breaker for relaxing the viscosity of the viscosified water component within a pre-determined period.

In another aspect of the invention, in its broadest form, the invention provides a method of fracturing a formation within a well comprising the steps of:
a) preparing a liquid component at surface in a blender, the liquid component including:
   i) a viscosified water component having a viscosity sufficient to temporarily support proppant admixed within the viscosified water component; and,
   ii) a breaker for relaxing the viscosity of the viscosified water component within a pre-determined period;
b) mixing the proppant into the liquid component in the blender;
c) introducing the proppant/liquid component into a high pressure pump and increasing the pressure to well pressure;
d) introducing a gas component into the high pressure pump and increasing the pressure to well pressure;
e) mixing the gas component with the proppant/liquid component under high turbulence conditions; and,
f) pumping the combined gas and fluid from step e) at a high rate down the well.

For both the compositions and methods, the predetermined period is preferably less than 30 minutes and more preferably less than 10 minutes. In various embodiments, the viscosity is relaxed to less than 10 cP.

In further embodiments, the fracturing fluid composition includes a proppant admixed within the viscosified water component.

The fracturing fluid composition may further comprise a gas component admixed with the liquid component under high turbulence conditions sufficient to support the proppant within a combined liquid component/gas component mixture wherein the combined liquid component/gas component mixture is characterized as a mist or liquid slug. It is preferred that the gas component is carbon dioxide or nitrogen.

In various embodiments, the combined fluid/gas component mixture is 3-15 vol % liquid component and 85-97 vol % gas component exclusive of the proppant.

In other embodiments, the initial viscosity of the liquid component is 15-100 centipoise (cP) at 170 sec⁻¹ prior to mixing with proppant or gas component and/or the mass of proppant is 0.25-5.0 times the mass of the liquid component. In a preferred embodiment, the mass of proppant is 1.0-2.5 times the mass of the liquid component.

The viscosified water component may comprise up to 50 vol % alcohol such as methanol as well as other additives including any one of or a combination of buffer (such as acetic acid), clay control agents (such as 40-80 wt % I-methaminium, 15-40 wt % ethylene glycol and water), non-foaming surfactant and alcohols.

In preferred embodiments, the viscosified water component includes 0.1-1.5 wt % guar gum such as carboxy methyl hydroxyl propyl guar.

In another embodiment, the breaker is preferably hemicellulase enzyme.

In yet another embodiment, the proppant is partially supported within the liquid component at surface by turbulence.

In yet another embodiment, the process of fracturing is continuous.

### BRIEF DESCRIPTION OF THE FIGURES

The invention is described with reference to the accompanying figures in which:

FIG. 1 is an overview of a typical equipment configuration for a fracturing operation in accordance with the invention;

FIG. 2 is a graph showing liquid component viscosity vs. time for different concentrations of breaker;

FIG. 3 is a graph showing foam stability vs. time for liquid component compositions having different concentrations of foaming or non-foaming surfactant agents;

FIG. 4 is a graph showing proppant support characteristics from sand sample accumulation times falling through fracturing compositions having different concentrations of foaming or non-foaming surfactant agents;

FIG. 5 is a graph showing proppant support characteristics from sand sample accumulation times falling through liquid component compositions having different concentrations of breaker.

### DETAILED DESCRIPTION

### Overview

With reference to the accompanying figures, novel fracturing compositions, methods of preparation and methods of use are described. Importantly, the subject technologies overcome problems in the use of mists as an effective fracturing composition particularly having regard to the ability of a mist to transport an effective volume of proppant into the formation. As a result, the subject technologies provide an effective economic solution to using high ratio gas fracturing compositions that can be produced in a continuous (i.e. non-batch) process without the attendant capital and operating costs of current pure gas fracturing equipment.

Generally, compositions prepared in accordance with the invention include a liquid component (water-based component) and a gas component in proportions that promote the formation of a mist. In the context of this description reference to a gas component refers to a compound that is a gas at standard temperature and pressure (273 K and 100 kPa) such as nitrogen, carbon dioxide, propane, methane or other gases that are used in fracturing. Such compounds may in the context of the invention be in a supercritical state at various times during a fracturing process. Accordingly, it is understood that while such compounds may be referred to as a “gas”, they may be exhibiting other properties such as those of liquids or supercritical fluids.

More specifically, the present compositions include a 3-15% liquid component (typically about 5%) and a 85-97% gas component (typically about 95%). In other embodiments, some of the water content within the liquid component may be made up with methanol to further reduce the water volume injected into the formation. In these embodiments, the liquid component may comprise up to 50 vol % methanol.

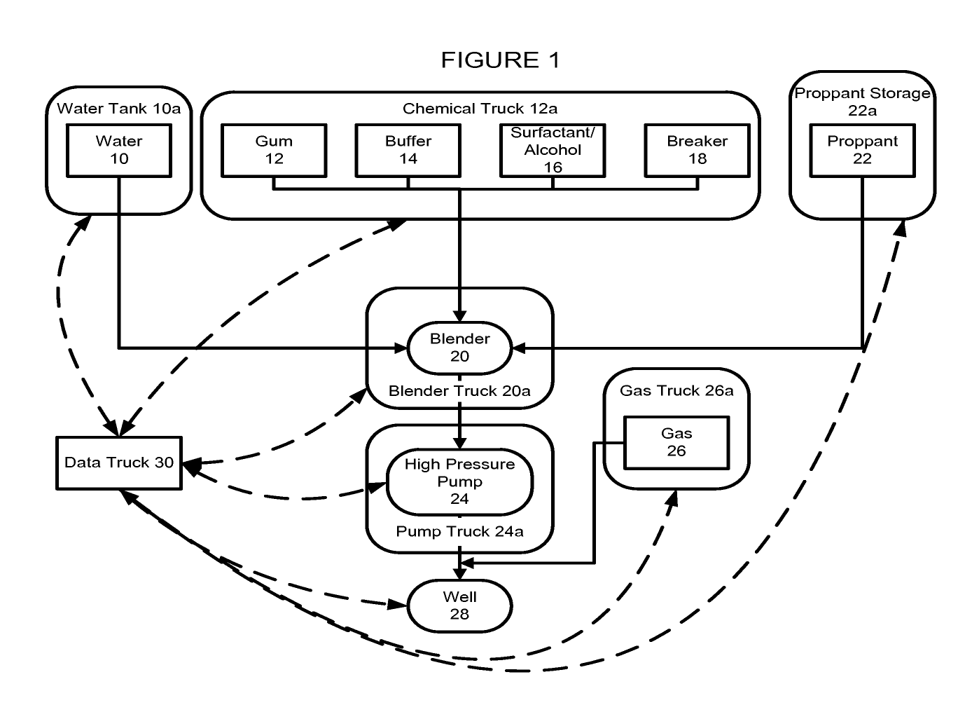

With reference to FIG. 1, fracturing fluid compositions are generally prepared and utilized in accordance with the following methodology:
a. A liquid component having desired properties is prepared at surface in a blender 20 with chemical additives from chemical truck 22a.
b. Proppant 22 is added to the liquid component;
c. The combined liquid/proppant mixture is introduced into a high pressure pump 24 and pressurized to well pressure;
d. A gas component (typically, nitrogen or liquid carbon dioxide) is introduced into a high pressure line leading to the well 28 where it mixes with the combined liquid/proppant mixture;
e. The pressurized combined liquid/proppant/gas is pumped at a high rate down the well 28;
f. The fracturing operation proceeds with the above fracturing fluid compositions being continuously prepared at the surface with varying ratios;
g. Upon completion, surface mixing and pressurization are ceased and the surface equipment is detached and removed from the well;
h. The well is flowed to remove as much fracturing gas and proppant as possible and turned over to production of hydrocarbons from the production zone.

As shown in FIG. 1, and as will be explained in greater detail below, the preparation and blending of the liquid and gas components is achieved at a well site utilizing portable equipment.

Importantly, in comparison to past non-energized, energized, foamed or emulsied fluid technologies, the subject technology does not require the supply of as high volume of fluids for injection nor the disposal of as high volumes of fluids recovered from the well as the relative proportion of water in the overall fracturing fluid composition is substantially lower than that of a non-energized, energized, foamed or emulsied fluid. In comparison to past 100% pure gas technologies, the subject technology, by virtue of the liquid component supporting proppant prior to mixing, the need for specialized, pressurized batch mixing equipment is eliminated.

### Fluid Compositions

### Liquid Component

The liquid component generally comprises (A) a linear gelled water, (B) a buffering agent, (C) a breaker, (D) a surfactant and (E) a clay control agent (F) alcohol(s). The liquid component is designed to impart adequate but short-lived viscosity to the liquid component such that proppant can be temporarily supported within the liquid component at surface without settling and plugging surface pumping equipment. It is further designed such that the viscosity of the liquid component promptly relaxes during and after fracturing to promote mist or liquid slug formation and ensure flow back to the well.

### A-Linear Gelled Water

The linear gelled water is formed from about 99 wt % water and 1 wt % gelling agent. Suitable linear gelling agents are for example guar gums (including guar gum derivatives and other gelling agents as known to those skilled in the art). Preferred guar gums are CMHPG (carboxy methyl hydroxy propyl guar). Guar gums are typically obtained as gum dissolved in a mineral oil so as to promote easy operation mixing and continuous mixing with water.

### B-Buffers

A buffering agent is added to the linear gelled water to impart various properties to the fracturing fluid. For example, buffers may be introduced to lower the pH of the liquid component to enhance breaker kinetics, maximize the gel hydration rate to quickly form viscosity or other functions as understood by those skilled in the art. Acetic acid is the active ingredient for a preferred buffering agent.

### C-Breaker

The breaker is typically an enzyme added to the liquid component for relaxing viscosity in a controlled manner such as hemicellulase. Typically, a breaker is selected that reduces liquid component viscosity over a maximum 30 minute time period and preferably 15 minutes or less. For example, liquid component viscosity may initially be in the range of 18-30 cP at a shear rate of 170 sec⁻¹ and be effectively reduced to 1-10 cP over a 5-60 minute period. The amount of enzyme, temperature, and pH of the liquid component are controlled to provide the relaxation in viscosity. Other suitable breakers include oxidizers or encapsulated breakers as known to those skilled in the art.

In one embodiment, breaker activity is controlled to relax viscosity within 10 minutes so as to more readily promote the formation of a mist or liquid slugs.

### D-Surfactant

Surfactant is a further additive that is intended to minimize damage by the fracturing fluid on the production zone and prevent the formation of foams. More specifically, the surfactant is designed to promote the return of the liquid component back to the well after pressure release by allowing less fluid to be squeezed into reservoir pores. Also flow-back may be increased by including compounds in the surfactant that reduce the contact angle and surface tension between water and the formation pores such that the water will flow out of the pores more rapidly as known to those skilled in the art.

### E-Clay Control Agents

Primarily, clay control agents are added to minimize damage (such as water damage) to the formation based on the formation-specific chemistry. Typical clay control agents are KCl, NaCl, ammonium chloride, and others as known to those skilled in the art.

### F-Alcohol(s)

Primarily, alcohols are added to minimize damage (such as water damage) to the formation based on the formation-specific chemistry. The alcohols can reduce the contact angle and surface tension and can behave as a solvent. Typical alcohols (such as methanol) are known to those skilled in the art.

With reference to Table 1, various liquid component compositions are described. In accordance with the invention, it is understood that the primary functions of the liquid component is to temporarily support proppant for a short time at surface prior to mixing with the gas component but not promote the formation of stable foams/emulsions on mixing. As such, various additives including surfactant, alcohol and clay control agents are not essential to the invention in that based on a specific application may not be added to the fluid composition. Similarly, the specific buffer may only be required to control the behavior of other additives such as the breaker and gelling agent.

TABLE 1
Liquid Component Additives

| | | Amount (% | | |
|---|---|---|---|---|
| | | of total | | |
| | | liquid | | Examples and/or Composition (% |
| | Additive | component) | | of unmixed component) |
| A-Linear Gelled | Water | 98-99 | wt % | Optionally, can contain KCl and/or |
| Water | | | | other salts up to 10% KCl. Salts |
| | | | | can provide clay control functions as |
| | | | | well. |
| | Guar | 0.1-2 | wt % | CMHPG (carboxy methyl hydroxy |
| | | | | propyl guar) (Century Oilfield |
| | | | | Services Inc., Calgary, Alberta) |
| B-Buffer | pH Buffer | <1.0 | vol % | Acetic Acid (40-70 wt %), Water (30-60 wt |
| | | | | %) (Century Oilfield Services |
| | | | | Inc., Calgary, Alberta) |
| C-Breaker | Enzyme | 0.01-5 | vol % | Hemicellulase Enzyme 0.1-5.0 wt % |
| | | | | diluted in Ethylene Glycol 15-40 wt |
| | | | | % and Water 60-85 wt % (Century |
| | | | | Oilfield Services Inc., Calgary, |
| | | | | Alberta) |
| D-Surfactant | Surfactant | <0.1 | vol % | Non-foaming Surfactant eg. Alkyl |
| | | | | Alkoxylate, Organic Polyol (Century |
| | | | | Oilfield Services Inc., Calgary, |
| | | | | Alberta) |
| E-Clay Control | Clay Control | <1.0 | vol % | I-Methaminium (40-80 wt %), |
| | | | | Ethylene Glycol (15-40 wt %), |
| | | | | remainder Water (Century Oilfield |
| | | | | Services Inc., Calgary, Alberta) |
| F-Alcohol(s) | Surface tension | <1.0 | vol % | Alcohol (40-90 wt %) (Century |
| | reducer | | | Oilfield Services Inc., Calgary, |
| | | | | Alberta) |

### Field Methodology and Equipment

As noted above, FIG. 1 shows an overview of the equipment and method of fracturing a well in accordance with the invention. Base fluids including water 10 (from water tank 10a), gelling agent 12, buffer 14, surfactant/alcohol 16 and breaker 18 (from a chemical truck 12a) are selectively introduced into a blender 20 (on blender truck 20a) at desired concentrations in accordance with the desired properties of the fluid composition. Upon establishment of the desired viscosity of the fluid composition, proppant 22 (from proppant storage 22a) is added to the composition and blended prior to introduction into a high pressure pump 24 (on pump truck 24a). Gas 26 (from gas truck 26a) is introduced to a high pressure line between the high pressure pump 24 and a well 28 prior to introduction into the well 28. A data truck 30 is configured to the equipment to collect and display real time data for controlling the equipment and to generate reports relating to the fracturing operation.

The blender blends the base fluids and proppant and chemical and includes appropriate inlets and valves for the introduction of the base fluids from the water tanks and chemical truck and proppant storage. The blender preferably includes a high shear tub capable of blending in the range of 1000-5000 kg (preferably about 2200 kg) of proppant per m³ of fluid.

The base liquid components including gum, buffer, surfactant, clay control, alcohol and breaker are delivered to a field site in a chemical truck 12a. The chemical truck includes all appropriate chemical totes, pumps, piping and computer control systems to deliver appropriate volumes of each base liquid component to the blender 20.

Water tanks 10a include valves to deliver water to the blender via the blender hoses.

The high pressure pump(s) typically each have a nominal power rating in the range of 1500 kW and be capable of pumping up to 2 m³/minute of liquid fracturing fluid and proppant through 4.5-5″ pump heads in order to produce downhole operating well pressures up to 15,000 psi. Depending on the size of the fracturing operation, 1-6 liquid high pressure pumps may be required.

Most commonly nitrogen is the gas used in field applications to dilute the slurry of fluid and proppant from the high pressure pump. For clarity in describing the fracturing fluid composition, in the industry and in the context of this description, it is known that nitrogen is bought and sold and measured in terms of its volume with reference to standard conditions (1 atm and 15 C or thereabouts) and referred to in units of “scm” (standard cubic meters or cubic meters under standard conditions as noted above). The physical state of nitrogen received at a well site is in a refrigerated liquid form stored at about 1 atm gauge pressure (2 atm absolute pressure) and about −145 C to −190 C. The ratio of 1 m³ of liquid nitrogen as delivered is equivalent to about 682 scm at standard atmospheric conditions. Nitrogen is pumped in its cryogenic liquid state taking it from storage pressure to well pressure, then gasified by heating it to 20 C, whereupon it enters the high pressure line where it mixes with the fracturing liquid composition and proppant.

This turbulent mixture is then pumped down the well where it warms up to as much as the formation temperature and reaches the pressures used to fracture the production zone. The estimated temperature and pressure under pumping conditions of the production zone is used to estimate the compression of nitrogen in the form of the number of standard cubic meters per cubic meter of actual space at the production zone.

For example, 1 m³/min of cryogenic liquid from the nitrogen truck may be pressurized to 20 MPa surface pressure, heated to 20 C, mixed with the fluid and proppant at the desired volume % ratios and pumped in the well to the formation. If the pumping pressure and temperature of fracturing into the production zone is 18 MPa and 30 C, the compression at these conditions is about 160 scm occupying 1 m³ of actual space. The 682 scm/min of nitrogen rate as it would be referred to in the field operations relates to an actual flow rate at the production zone during fracturing of 4.26 m³/min (682 scm/min divided by the compression ratio of 160 scm/m³). When the frac is flowed back, as pressure and temperature changes the nitrogen gas expands as it flows with fluid to flow back tanks at surface for separation and disposal.

Generally, the fracturing composition is formulated for a desired composition input to the formation at formation conditions. As such, the ratio between the fluid component and gas component as measured in volume % at the surface will likely be different to what is delivered to the formation. As known to those skilled in the art, the difference between surface pressure and bottom hole pressure may have either a positive or negative variance depending on parameters including the hydrostatic pressure and friction pressures between the surface and the formation. For example, for a typical fracturing composition in accordance with the invention, where a 10/90 volume % liquid/gas composition is to be injected at the formation, may depending on the depth of the formation and the friction pressures of the specific composition conveyance equipment require either higher or lower ratio of liquid to gas mixing at surface at a given surface pressure.

In some embodiments, carbon dioxide is used to dilute the fluid and proppant. In this case, the storage vessel is under storage conditions of about 150 psi and about −30 C. Carbon dioxide vessels may also be pressured to 300 psi with nitrogen gas to boost the pressure of the vessel during the fracturing operation. Carbon dioxide liquid is suctioned from the bulk vessel and/or pushed with nitrogen gas to a high pressure pump identical to the fluid pump to increase the carbon dioxide to well pressure. The carbon dioxide mixes with the fluid and proppant and is pumped into the well and ultimately into the production zone. The carbon dioxide warms up and turns to a gas while flowing back with any well fluids into flow back tanks at surface for separation and disposal.

### Lab Examples

Test samples of the fluid composition were prepared in accordance with the following general methodology. A volume of a base fluid (for example water) was measured in a beaker from a bulk source and added to a variable speed Waring blender. The fracturing liquid component additives were measured in disposal plastic syringes from bulk sources. The Waring blender was turned on to an appropriate speed and the additives were added to the base fluid sequentially. The samples were blended for about 0.5 minutes (or slightly longer as required). To foam a sample, the Waring blender was turned to a higher speed setting for at least 10 seconds. The fracturing fluid test sample was then ready to be used in the various experiments.

Test samples of the proppant (sand) were prepared in accordance with the following general methodology. A volume of 20/40 Ottawa white sand was taken from a bulk source in a beaker. Two API sand sieves and a pan were stacked such that a 30 mesh pan was at the top, a 35 mesh pan was in the middle and a collection pan was at the bottom. The sand sample was slowly poured on the top sieve and the stack of sieves was agitated using a sieve shaker for about 5 minutes. The sand that fell through the 30 mesh sieve and was held on the 35 mesh sieve was used in the various experiments. Otherwise, various mesh ranges of various proppants as commonly available to industry were used in the various experiments.

Test samples of the fluid were measured for proppant (sand) support under static conditions using the following general methodology. A fracturing fluid composition was prepared and a sand sample was obtained according the previous methodologies described. 90% of the volume of a fluid sample was blended without sand in one Waring blender. The remaining 10% of the volume of a fluid sample was blended with sand in a second Waring blender. The fluid sample without proppant was quickly placed in a graduated cylinder with the sand laden fluid sample placed on top. The sand volume accumulation was observed at the bottom of the graduated cylinder and compared to the initial proppant sample used. A longer accumulation time (i.e. a lower fall rate for the particles) indicated a greater tendency of the fracturing fluid to support proppant.

Test samples of the fluid were measured for viscosity with the following general methodology. A Brookfield PVS rheometer (Brookfield Engineering Laboratories, Middleboro, Mass.) was utilized to measure the viscosity of the liquid fracturing fluid compositions. The oil bath temperature was set to a specific temperature according to each experiment. 250 mL of liquid fracturing fluid composition was blended in a Waring blender. A 50 mL plastic syringe was used to transfer a 35 mL sample from the prepared liquid fracturing fluid composition in the Waring blender to the rheometer cup. The cup was screwed on the rheometers such that the bob was appropriately immersed in the fluid, the sealed cup was exposed to 400 psi nitrogen pressure above the fluid, and the cup immersed in the oil bath for temperature control according to the general procedures as known to those skilled in the art.

### Experiments

Viscosity vs. Time

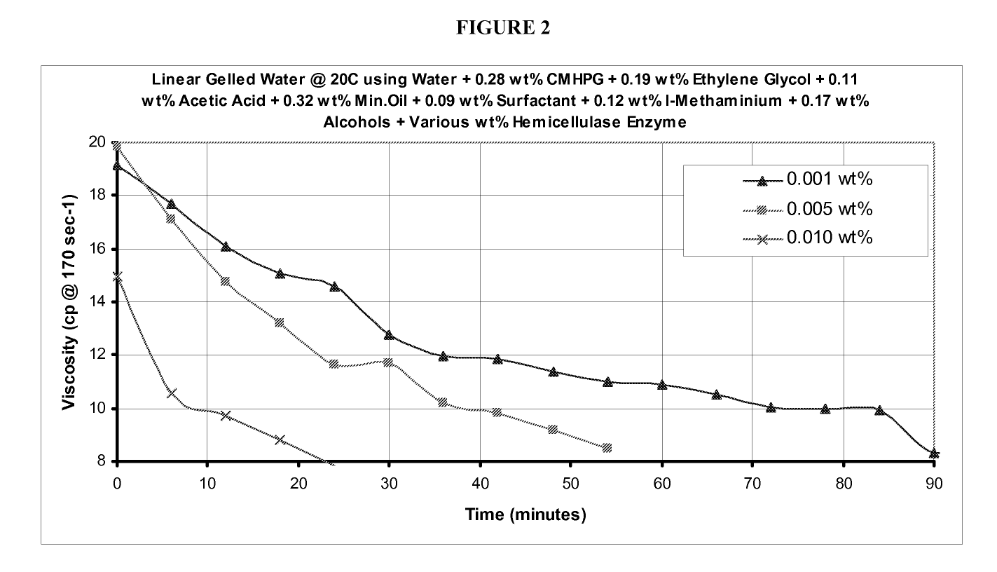

FIG. 2 shows the effect of varying breaker concentration on viscosity of a liquid fracturing fluid composition as a function of time. The fluid composition was a blend of water with additive concentrations of 0.28 wt % CMHPG, 0.19 wt % Ethylene Glycol, 0.11 wt % Acetic Acid, 0.32 wt % Mineral Oil, 0.09 wt % Non-foaming Surfactant, 0.12 wt % I-Methaminium, 0.17 wt % Alcohols, and various loadings of hemicellulase enzyme solution. The viscosity was measured at 20° C. and a shear rate of 170 sec⁻¹. As shown, as the breaker concentration is varied from 0.001-0.010 wt %, the viscosity of the fluid composition relaxes in approximately one tenth of the time to 10 cP at a shear rate of 170 sec⁻¹ (8 minutes compared to 72 minutes).

Most fracturing stimulation operations finish in more time than 8 minutes. The standard, as known to those skilled in the art, is to have higher viscosity values until the time planned for the fracturing stimulation is reached, or by default, about 90 minutes. This invention demonstrates that the temporary viscosity of the fracturing fluid is brought below 10 cP (considered a “broken” or relaxed fluid) before the fracturing stimulation operation is finished.

### Foam Stability

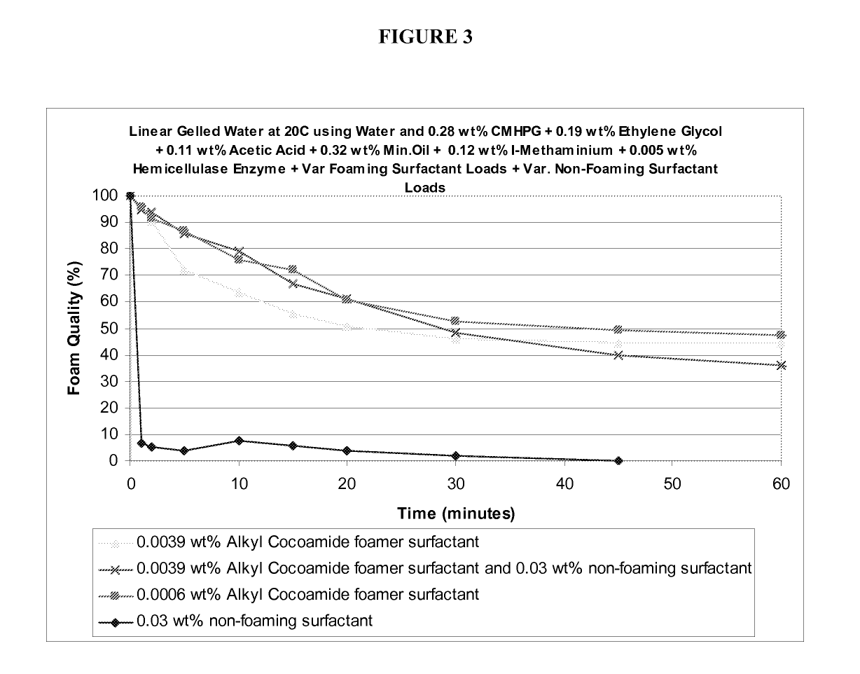

FIG. 3 shows the effect of introducing additives that are known foaming agents as compared to other additives with a null effect on foaming by measuring foam stability as a function of time. A blend of water base fluid with additive concentrations of 0.28 wt % CMHPG, 0.19 wt % Ethylene Glycol, 0.11 wt % Acetic Acid, 0.32 wt % Mineral Oil, 0.12 wt % I-Methaminium, 0.005 wt % Hemicellulase Enzyme, and various additives and loadings of foaming surfactant agents and non-foaming surfactant agents are shown in FIG. 3. In these experiments, the liquid fracturing fluid composition was agitated in a Waring blender at the 100% (maximum) speed setting to produce a foam. After cessation of agitation, the height of the foam was measured immediately and at time intervals thereafter. As shown, a reduction in the amount of foaming surfactant agent from 0.0039 wt % (a standard foaming agent and a common concentration used to produce emulsions and foams) to 0.0006 wt % (a very low amount) both resulted in reasonable foam stability. Reasonable foam stability was also observed with foaming surfactant agent of 0.0039 wt % combined with 0.03 wt % of a non-foaming surfactant agent which shows that non-foaming surfactant agent neither encourages or discourages the generation of a stable foam. However, a fluid containing 0.03 wt % of a non-foaming surfactant agent and the absence of a foaming surfactant agent showed an almost instant collapse of foam stability after cessation of agitation.

### Proppant Support

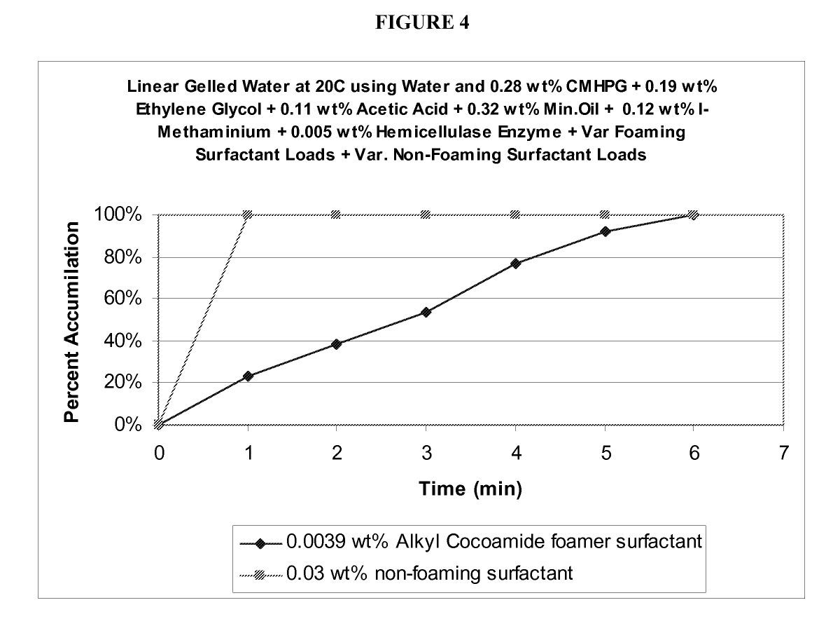

FIG. 4 shows the effect of proppant support in various fracturing fluid compositions that have varying foam stability. 350 mL of a common fracturing fluid composition (foamed if capable) was created using a water base fluid with additive concentrations of 0.28 wt % CMHPG, 0.19 wt % Ethylene Glycol, 0.11 wt % Acetic Acid, 0.32 wt % Mineral Oil, 0.12 wt % I-Methaminium, 0.005 wt % Hemicellulase Enzyme, and various additives and loadings as noted in FIG. 4. When 0.0039 wt % of a foaming surfactant agent is used in the fracturing fluid composition, a stable foam was created, and the time for 100% accumulation of the 30/35 mesh sand sample at the bottom of the graduated cylinder was 6 minutes. This equated to a fall rate (for the whole sample) of 3.92 cm/min. When a foaming surfactant agent was not used, 0.03 wt % of a non-foaming surfactant agent was used, and a stable foam was not created, and the time for 100% accumulation of the 30/35 mesh sand sample at the bottom of the graduated cylinder was less than 1 minute. This equated to a fall rate (for the whole sample) of >13.4 cm/min.

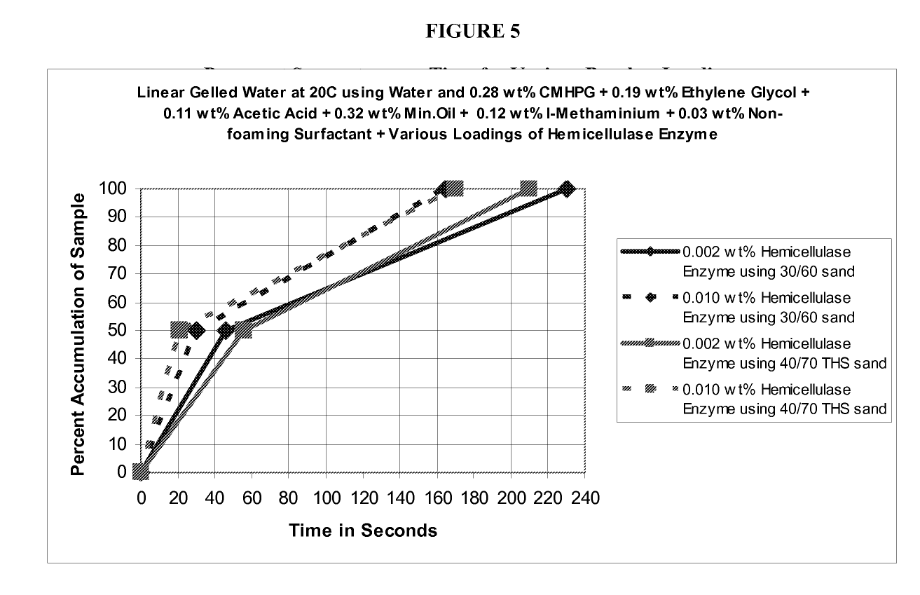

FIG. 5 shows the effect of proppant support in various fracturing fluid compositions that have varying breaker loadings. 350 mL of a common fracturing fluid composition was created using a water base fluid with additive concentrations of 0.28 wt % CMHPG, 0.06 wt % Ethylene Glycol, 0.11 wt % Acetic Acid, 0.32 wt % Mineral Oil, 0.03 wt % Surfactant, 0.12 wt % I-Methaminium, 0.17 wt % Alcohols, and various loadings of Hemicellulase Enzyme breaker. The fracturing compositions were mixed for 5 minutes prior to being used for the experiment to allow for the varying breaker amounts to cause a varying viscosity for the samples. Two different proppants were measured that had varying absolute SG and mesh size ranges. 30/60 mesh Canadian sand was used (SG of 2.61), and 40/70 mesh Santrol THS pre-cured resin coated sand was used (SG of 2.43). Two sand sample settle rates were measured for each of the two proppant types, at the “industry common” breaker loading of 0.002 wt % and 0.010 wt %. FIG. 5 shows the sand sample accumulation times for each of the 4 trials. For 30/60 mesh Canadian sand, the fall rate of 3.36 cm/minute increased by 39.4% to 2.75 cm/minute with breaker loadings of 0.002 wt % and 0.010 wt % respectively. For 40/70 mesh Santrol THS pre-cured resin coated sand, the fall rate of 3.5 cm/minute increased by 23.5% to 2.83 cm/minute with breaker loadings of 0.002 wt % and 0.010 wt % respectively. With both proppant types and mesh sizes, the higher breaker loading fluid supported the proppant less effectively.

### FIELD EXAMPLES

The following are representative examples of field trials of the subject technology.

### Field Example 1

### 42-20W4

The well was characterized by having perforations from 765 to 767 m in the Medicine Hat formation production zone. The stimulation was pumped down 114.4 mm, 14.14 kg/m, J-55 casing to attempt to place 10,000 kg of 20/40 sand into the production zone.

Prior to the fracture, the well was not flowing economically.

At the job site, all truck-mounted equipment was positioned and connected in accordance with standard operating practice. All fluid tanks were filled with 80 vol % fresh water and 20 vol % methanol. Water and methanol was heated to 20-25° C. prior to the fracturing operation.

The wellhead was pressure tested to 30 MPa with a maximum working pressure of 26.0 MPa.

At the perforation zone, an initial 100% nitrogen pad of 2006 scm (standard cubic meters) was injected into the producing zone to create at least one fracture at the rate of 576 scm/minute. After the initial 100% nitrogen pad, a fluid composition having a base fluid of 20 vol % methanol and 80 vol % water with the additives of 0.28 wt % CMHPG, 0.19 wt % Ethylene Glycol, 0.11 wt % Acetic Acid, 0.32 wt % Mineral Oil, 0.03 wt % Surfactant, 0.12 wt % I-Methaminium, 0.17 wt % Alcohols, 7 wt % KCl, and 0.005 wt % Hemicellulase Enzyme was prepared in the blender.

Proppant (20/40 mesh sand) was admixed to the fluid composition at a ratio of 2000 kg of sand per m³ of fluid. As known to those skilled in the art there may be several stages and fluid and proppant ratios developed before the well is flushed.

The rate of fluid/sand slurry mixture started at 0.63 m³/min and increased to 0.96 m³/min during the proppant pumping. The overall perforation equivalent rate of gas, fluid and proppant in the formation was estimated to start at 5.09 m³/min and decrease to 3.16 m³/min during the proppant stages.

Nitrogen gas was introduced to the high pressure line between the high pressure pump and well head. The nitrogen gas rate was varied to result in 4 different rates ranging from 577 scm/min down to 284 scm/min which diluted the fluid and sand composition pumped down the well head to the formation. The gas quality (gas volume at the perforations divided by the gas and fluid volume at the perforations) was 100% in the pad and ranged between 93% and 80% in the proppant/fluid stages to result in an overall inject gas quality placed in the formation of 87.6%. This did not include the flush of the well of proppant, and only the material that passed the perforations to get into the production zone. The overall concentration of sand started at 100 kg of sand/m³ of combined fluid and gas and increased to 400 kg m³ of combined fluid and gas.

Overall, the surface pressure during fracturing varied from about a lowest value of 11.2 MPa to 13.4 MPa with an initial surface breakdown pressure to initiate the frac at 15.2 MPa. In total, 9860 kg of proppant was delivered to the formation in 20 minutes from the time that the fracture operations started pumping until the well was flushed of proppant.

Upon completion, the well was vacated and an estimated 2.4 m³ of fluid was recovered from the well for disposal. In comparison to an energized fluid frac, this represented a 3 fold decrease in the amount of water and methanol requiring disposal.

Gas flow rates from the well after fracturing averaged 3.81 E3M3/day flowing during the following 5 weeks.

### Field Example 2

### 42-20W4

The well was characterized by having perforations from 784 to 787 m in the Medicine Hat formation production zone. The stimulation was pumped down 114.4 mm, 14.14 kg/m, J-55 casing to attempt to place 10,600 kg of 20/40 sand into the production zone.

Prior to the fracture, the well was not flowing economically.

At the job site, all truck-mounted equipment was positioned and connected in accordance with standard operating practice. All fluid tanks were filled with 80 vol % fresh water and 20 vol % methanol. Water and methanol was heated to 20-25° C. prior to the fracturing operation.

The wellhead was pressure tested to 30 MPa with a maximum working pressure of 26.0 MPa.

At the perforation zone, an initial 100% nitrogen pad of 2070 scm was injected into the producing zone to create at least one fracture at the rate of 576 scm/minute. After the initial 100% nitrogen pad, a fluid composition having a base fluid of 20 vol % methanol and 80 vol % water with the additives of 0.28 wt % CMHPG, 0.19 wt % Ethylene Glycol, 0.11 wt % Acetic Acid, 0.32 wt % Mineral Oil, 0.03 wt % Surfactant, 0.12 wt % I-Methaminium, 0.17 wt % Alcohols, 7 wt % KCI, and 0.005 wt % Hemicellulase Enzyme was prepared in the blender.

Proppant (20/40 mesh sand) was admixed to the fluid composition at a ratio of 2000 kg of sand per m³ of fluid.

The rate of fluid/sand slurry mixture started at 0.63 m³/min and increased to 0.96 m³/min during the proppant pumping. The overall perforation equivalent rate of gas, fluid and proppant in the formation was estimated to start at 5.09 m³/min and decrease to 3.16 m³/min during the proppant stages.

Nitrogen gas was introduced to the high pressure line between the high pressure pump and well head. The nitrogen gas rate was varied to result in 4 different rates ranging from 577 scm/min down to 284 scm/min which diluted the fluid and sand composition pumped down the well head to the formation. The gas quality (gas volume at the perforations divided by the gas and fluid volume at the perforations) was 100% in the pad and ranged between 93% and 80% in the proppant/fluid stages to result in an overall inject gas quality placed in the formation of 87.6%. This did not include the flush of the well of proppant, and only the material that passed the perforations to get into the production zone. The overall concentration of sand started at 100 kg of sand/m³ of combined fluid and gas and increased to 400 kg m³ of combined fluid and gas.

Overall, the surface pressure during fracturing varied from about a lowest value of 11.1 MPa to 13.4 MPa with an initial surface breakdown pressure to initiate the frac at 15.1 MPa. In total, 10430 kg of proppant was delivered to the formation in 20 minutes from the time that the fracture operations started pumping until the well was flushed of proppant.

Upon completion, the well was vacated and an estimated 2.5 m³ of fluid was recovered from the well for disposal. In comparison to an energized fluid frac, this represented a 3 fold decrease in the amount of water and methanol requiring disposal.

Gas flow rates from the well after fracturing were 4.77 E3M3/day the following calendar month that the well was produced full time.

### Field Example 3

### 42-19W4

The well was characterized by having perforations from 259 to 260 m in the Belly River formation production zone with the well isolated below 270 m. The stimulation was pumped down 114.4 mm, 14.14 kg/m, J-55 casing to attempt to place 7,000 kg of 20/40 sand into the production zone.

Prior to the fracture, the well was flowing 0.42 to 0.59 E3M3/day flowing in the calendar year prior to the fracturing of this zone.

At the job site, all truck-mounted equipment was positioned and connected in accordance with standard operating practice. All fluid tanks were filled with fresh water. Water was heated to 20-25° C. prior to the fracturing operation.

The wellhead was pressure tested to 30 MPa with a maximum working pressure of 26.0 MPa.

At the perforation zone, an initial 100% nitrogen pad of 1780 scm was injected into the producing zone to create at least one fracture at the rate of 296 scm/minute. After the initial 100% nitrogen pad, a fluid composition having a base fluid of water with the additives of 0.28 wt % CMHPG, 0.19 wt % Ethylene Glycol, 0.11 wt % Acetic Acid, 0.32 wt % Mineral Oil, 0.03 wt % Surfactant, 0.12 wt % I-Methaminium, 0.17 wt % Alcohols, and 0.005 wt % Hemicellulase Enzyme was prepared in the blender.

Proppant (20/40 mesh sand) was admixed to the fluid composition at a ratio of 1500 to 2000 kg of sand per m³ of fluid.

The rate of fluid/sand slurry mixture started at 0.57 m³/min and increased to 1.58 m³/min during the proppant pumping. The overall perforation equivalent rate of gas, fluid and proppant in the formation was estimated to vary between 4.82 m³/min and 5.18 m³/min during the proppant stages.

Nitrogen gas was introduced to the high pressure line between the high pressure pump and well head. The nitrogen gas rate was varied to result in 4 different rates ranging from 262 scm/min down to 216 scm/min which diluted the fluid and sand composition pumped down the well head to the formation. The gas quality (gas volume at the perforations divided by the gas and fluid volume at the perforations) was 100% in the pad and ranged between 93% and 80% in the proppant/fluid stages to result in an overall injection gas quality placed in the formation of 96.6%. This did not include the flush of the well of proppant, and only the material that passed the perforations to get into the production zone. The overall concentration of sand started at 116 kg of sand/m³ of combined fluid and gas and increased to 400 kg m³ of combined fluid and gas.

Overall, the surface pressure during fracturing varied from about a lowest value of 7.5 MPa to 8.8 MPa with an initial surface breakdown pressure to initiate the frac at 12.5 MPa. In total, 7,000 kg of proppant was delivered to the formation in 13 minutes from the time that the fracture operations started pumping until the well was flushed of proppant.

Upon completion, the well was vacated and an estimated 1.5 m³ of fluid was recovered from the well for disposal. In comparison to an energized fluid frac, this represented a 4 fold decrease in the amount of water and methanol requiring disposal.

Gas flow rates from the well after fracturing were 0.93 to 1.30 E3M3/day the following 9 calendar months.

### Field Example 4

### 51-08W5

The well was characterized by having perforations existing that were on production previously as well as a new set of perforations in the Edmonton formation production zone as shown in Table 2 in the “Perforation Interval” column. The casing was isolated below 665 m. The stimulation was pumped down 73 mm (8.13 kg/m HS70) coiled tubing utilizing zonal isolation cups in 114.4 mm, 14.14 kg/m, J-55 casing to attempt to place 20,000 kg of 20/40 sand into the production zones in a manner as stated in the “Sand Pumped” column of Table 2.

TABLE 2
Field Example 4

| | | | Total | Rev. | N2 | Sand | Break | Min | Max | Ave |
|---|---|---|---|---|---|---|---|---|---|---|
| | | N2 Pad | Fluid | N2 | Total | Pumped. | Pressure | Pressure | Pressure | Pressure |
| Perforation Interval | | (scm) | (m³) | (scm) | (scm) | (1000s kg) | (MPa) | (MPa) | (MPa) | (MPa) |
| 533 to 534 m | Old | 2000 | 2.67 | 2150 | 4950 | 3.00 | 21.8 | 20.5 | 30.3 | 26.8 |
| 510 to 512 m | Old | 2000 | 2.64 | 0.0 | 4820 | 3.00 | 23.4 | 22.0 | 30.6 | 26.3 |
| 498 to 500 m | Old | 2000 | 2.69 | 0.0 | 5200 | 3.00 | 31.0 | 23.3 | 29.4 | 27.4 |
| 477 to 479 m | Old | 2000 | 2.59 | 0.0 | 4780 | 3.00 | 37.8 | 22.1 | 29.7 | 27.6 |
| 434.5 to 435.5 m | New | 2000 | 2.63 | 300 | 4300 | 3.00 | 33.5 | 20.9 | 33.7 | 30.3 |
| 315 to 317 m | Old | 3000 | 3.53 | 500 | 7800 | 5.00 | 18.8 | 17.5 | 30.3 | 27.4 |

Prior to the fracture, the well was flowing between 0.51 and 1.30 E3M3/day flowing (average of 0.85 E3M3/day flowing) in the 12 to 24 calendar months before fracture. The well was shut in for about 12 calendar months which built up pressure. The calendar month before the fracture an instantaneous flow rate averaged 3.55 E3M3/day flowing which was influenced by the built up pressure over a short period of time.

At the job site, all truck-mounted equipment was positioned and connected in accordance with standard operating practice. All fluid tanks were filled with 80 vol % fresh water and 20 vol % methanol. Water and methanol was heated to 20-25° C. prior to the fracturing operation. The coiled tubing was pressure tested to 44 MPa with a maximum working pressure of 40 MPa.

At the perforation zone, an initial 100% nitrogen pad (volume in the “N2 Pad” column of Table 2) was injected into the producing zone to create at least one fracture at the rate of 585 scm/minute. After the initial 100% nitrogen pad, a fluid composition having a base fluid of 20 vol % methanol and 80 vol % water with the additives of 0.28 wt % CMHPG, 0.19 wt % Ethylene Glycol, 0.11 wt % Acetic Acid, 0.32 wt % Mineral Oil, 0.03 wt % Surfactant, 0.12 wt % I-Methaminium, 0.17 wt % Alcohols, and 0.005 wt % Hemicellulase Enzyme was prepared in the blender.

Proppant (20/40 mesh sand) was admixed to the fluid composition at a ratio of 2000 kg of sand per m³ of fluid.

The rate of fluid/sand slurry mixture started at 0.61 m³/min and increased to 1.14 m³/min during the proppant pumping. The overall perforation equivalent rate of gas, fluid and proppant in the formation was estimated to vary between 6.00 m³/min and 6.11 m³/min during the proppant stages.

Nitrogen gas was introduced to the high pressure line between the high pressure pump and well head. The nitrogen gas rate was varied to result in 4 different rates ranging from 525 scm/min down to 485 scm/min which diluted the fluid and sand composition pumped down the well head to the formation. The gas quality (gas volume at the perforations divided by the gas and fluid volume at the perforations) was 100% in the pad and ranged between 94% and 88% in the proppant/fluid stages to result in an overall inject gas quality placed in the formation of 96.3%. This did not include the flush of the well of proppant, and only the material that passed the perforations to get into the production zone. The overall concentration of sand started at 122 kg of sand/m³ of combined fluid and gas and increased to 235 kg/m³ of combined fluid and gas.

Overall, the surface pressure during fracturing varied between a minimum and maximum pressure as stated in the “Min Pressure” and “Max Pressure” columns of Table 2. Initial surface breakdown pressures to initiate the fractures are shown in the “Breakdown Pressure” column of Table 2. In total, 20,000 kg of proppant was delivered to the formation intervals as shown in Table 2 in the “Sand Pumped” column.

Upon completion, the well was vacated and an estimated 10 m³ of fluid was recovered from the well for disposal. In comparison to an energized fluid frac, this represented a 4 fold decrease in the amount of water and methanol requiring disposal.

Gas flow rates from the well after fracturing were between 1.14 and 6.62 E3M3/day flowing (average of 3.23 E3M3/day flowing) the following 5 calendar months from the previously producing and one new production zones. This represents a 4 fold increase in production.

### CONCLUSION

In summary, the lab and field test data showed that substantially lower quantities of water can be used to create fracturing compositions that in combination with novel mixing and pumping methods are effective in providing high mass proppant fractures. Importantly, the subject technologies demonstrated that the use of mists can be used as an effective fracturing composition particularly having regard to the ability of a mist to transport an effective volume of proppant into the formation using conventional fracturing equipment. As a result, the subject technologies provide an effective economic solution to using high concentration gas fracturing compositions that can be produced in a continuous (ie non-batch) process without the attendant capital and operating costs of current pure gas fracturing equipment.

1. A fracturing fluid composition comprising:
a liquid component for temporarily supporting a proppant within the liquid component at surface, the liquid component including:
i) a viscosified water component having a viscosity sufficient to temporarily support proppant admixed within the viscosified water component; and
ii) a breaker for relaxing the viscosity of the viscosified water component within a pre-determined period.

2. A fracturing fluid composition as in claim 1 further comprising a proppant admixed within the viscosified water component.

3. A fracturing fluid composition as in claim 2 further comprising a gas component admixed with the liquid component under high turbulence conditions sufficient to support the proppant within a combined liquid component/gas component mixture wherein the combined liquid component/gas component mixture is characterized as a mist or liquid slug.

4. A fracturing fluid composition as in claim 3 wherein the gas component is carbon dioxide or nitrogen.

5. A fracturing fluid composition as in claim 3 wherein the combined fluid/gas component mixture is 3-15 vol % liquid component and 85-97 vol % gas component exclusive of the proppant.

6. A fracturing fluid composition as in claim 1 wherein the pre-determined period is less than 30 minutes.

7. A fracturing fluid composition as in claim 1 wherein the pre-determined period is less than 10 minutes.

8. A fracturing fluid composition as in claim 1 wherein the initial viscosity of the liquid component is 15-100 centipoise (cP) at 170 sec⁻¹ prior to mixing with proppant or gas component.

9. A fracturing fluid composition as in claim 2 wherein the mass of proppant is 0.25-5.0 times the mass of the liquid component.

10. A fracturing fluid composition as in claim 2 wherein the mass of proppant is 1.0-2.5 times the mass of the liquid component.

11. A fracturing fluid composition as in claim 1 wherein the concentration of breaker within the liquid component is sufficient to relax the initial viscosity of the liquid component to less than 10 cP at 170 sec⁻¹ within 30 minutes.

12. A fracturing fluid composition as in claim 1 wherein the concentration of breaker within the liquid component is sufficient to relax the initial viscosity of the liquid component to less than 10 cP at 170 sec⁻¹ within 10 minutes.

13. A fracturing fluid composition as in claim 1 wherein the viscosified water component comprises up to 50 vol % alcohol.

14. A fracturing fluid composition as in claim 12 wherein the alcohol is methanol.

15. A fracturing fluid composition as in claim 1 wherein the liquid component further comprises less than 1 vol % buffer.

16. A fracturing fluid composition as in claim 14 wherein the buffer is acetic acid.

17. A fracturing fluid composition as in claim 1 wherein the viscosified water component includes 0.1-2.0 wt % guar gum.

18. A fracturing fluid composition as in claim 16 wherein the guar gum is carboxy methyl hydroxyl propyl guar.

19. A fracturing fluid composition as in claim 1 wherein the breaker is hemicellulase enzyme.

20. A fracturing fluid composition as in claim 1 wherein the liquid component further comprises less than 0.1 vol % non-foaming surfactant.

21. A fracturing fluid composition as in claim 1 further comprising less than 1 vol % clay control agent.

22. A fracturing fluid composition as in claim 21 wherein the clay control agent includes 40-80 wt % 1-methaminium, 15-40 wt % ethylene glycol and water.

23. A method of fracturing a formation within a well comprising the steps of:
a. preparing a liquid component at surface in a blender, the liquid component including:
i. a viscosified water component having a viscosity sufficient to temporarily support proppant admixed within the viscosified water component; and,
ii. a breaker for relaxing the viscosity of the viscosified water component within a pre-determined period;
b. mixing the proppant into the liquid component in the blender;
c. introducing the proppant/liquid component into a high pressure pump and increasing the pressure to well pressure;
d. introducing a gas component into the high pressure pump and increasing the pressure to well pressure
e. mix the gas component with the proppant/liquid component under high turbulence conditions; and,
f. pumping the combined gas and fluid from step e) at a high rate down the well.

24. A method as in claim 23 wherein the combined gas and fluid in step f) is characterized as a mist or slug at the formation.

25. A method as in claim 23 wherein the gas component is carbon dioxide or nitrogen.

26. A method as in claim 23 wherein the combined gas and fluid in step f) is 3-15 vol % liquid component and 85-97 vol % gas component exclusive of the proppant.

27. A method as in claim 23 wherein the pre-determined period is less than 30 minutes.

28. A method as in claim 23 wherein the pre-determined period is less than 10 minutes.

29. A method as in claim 23 wherein the initial viscosity of the viscosified water component is 15-100 centipoise (cP) at 170 sec⁻¹ prior to mixing with proppant or gas component.

30. A method as in claim 23 wherein the mass of proppant mixed in step b) is 1.0-5.0 times the mass of the liquid component.

31. A method as in claim 23 wherein the concentration of breaker within the liquid component is sufficient to relax the initial viscosity of the liquid component to less than 10 cp at 170 sec⁻¹ within 30 minutes.

32. A method as in claim 23 wherein the concentration of breaker within the liquid component is sufficient to relax the initial viscosity of the liquid component to less than 10 cp at 170 sec⁻¹ within 10 minutes.

33. A method as in claim 23 wherein the viscosified liquid component includes up to 50 vol % alcohol.

34. A method as in claim 33 wherein the alcohol is methanol.

35. A method as in claim 23 further comprising the step of mixing less than 1 vol % buffer with the liquid component.

36. A method as in claim 35 wherein the buffer is acetic acid.

37. A method as in claim 23 wherein the viscosified liquid component includes 0.1 to 2.0 wt % guar gum.

38. A method as in claim 37 wherein the guar gum is carboxy methyl hydroxyl propyl guar.

39. A method as in claim 23 wherein the breaker is hemicellulase enzyme.

40. A method as in claim 23 further comprising the step of mixing less than 0.1 vol % non-foaming surfactant with the viscosified liquid component.

41. A method as in claim 23 further comprising the step of mixing less than 1 vol % clay control agent with the viscosified liquid component.

42. A method as in claim 23 wherein proppant is partially supported within the liquid component at surface by turbulence.

43. A method as in claim 23 wherein the process is continuous.
